(19) United States
(12) Patent Application Publication
(10) Pub. No.: US 2003/0024330 A1
(43) Pub. Date: Feb. 6, 2003

(54) Apparatus and method

(76) Inventors: Mitchell Stuart Davidson, Aberdeen (GB); Colin Douglas Campbell, Alford (GB); Stephen James Chapman, Aberdeenshire (GB)

Correspondence Address: Robert E. Cannuscio, Esquire, DRINKER BIDDLE & REATH LLP, One Logan Square, 18th & Cherry Streets, Philadelphia, PA, 19103-6996, US

(21) Appl. No.: 10/209,548

(22) Filed: Jul. 31, 2002

(30) Foreign Application Priority Data
Jul. 31, 2001 (GB) 0118620.4

(51) Int. Cl. G01N 1/16; G01N 1/26

(52) U.S. Cl. 73/863.31

(57) ABSTRACT

An apparatus and method for determining the content or measuring the quantity of constituents, of a plurality of samples (12) is provided, being particularly useful for measuring the amount of CO₂ released by soil samples (12). The apparatus includes a first plate (10) having a plurality of wells (11), each well (11) being intended to contain a sample (12), and a second plate (20) also having a plurality of wells (21), each well (21) of the second plate (20) being intended to contain an indicating means such as a gel with a PH indicator (22). A third plate (30) may be provided to connect the wells (11) of the first plate (10) to the second plate (20) such that at least one well (11) of the first plate (10) communicates with at least one well (21) of the second plate (20).

### FIELD OF THE INVENTION

This invention relates to an apparatus and method for performing a plurality of tests for detecting the presence of, or more particularly the amount of, fluid emanating from a plurality of samples and particularly, but not exclusively, to the amount or presence of carbon dioxide (CO₂) released from a plurality of soil samples.

### BACKGROUND OF THE INVENTION

When assessing the health and activity of soil, a known method is to measure the amount of CO₂ that is being respired by soil microorganisms that are decomposing organic substrates in the soil. It is also possible to measure the Substrate-Induced Respiration (SIR) by measuring the CO₂ being respired before and after the addition of a substrate such as glucose. This SIR method gives additional information on how different soils might respond to stress and or the addition of pollutants and organic matter. The individual species that comprise the soil microbial community have differing capabilities to respire different substrates, such that by adding different substrates it is possible to measure a catabolic fingerprint of the community or Community Level Physiological Profile (CLPP).

However, measuring the respiration of a large number (e.g. 1695) of carbon sources can be laborious and time consuming as most methods use between 5-150 g of soil in 100 ml or 2.5 l glass jars. The methods of measurement can be difficult to automate and to process large numbers of samples.

Other methods of testing multiple C sources rely upon extraction of the community from the soil before inoculation into a microtitre (synonym ‘multiwell’) test plate and subsequent growth in the test plate (e.g. Biolog®). However, one of the disadvantages of this type of CLPP method for determining soil microbial community diversity is that the result is then biased towards organisms that are, firstly, readily extractable and, secondly, able to develop rapidly within the aqueous environment of a microtitre plate test well.

### SUMMARY OF THE INVENTION

According to a first aspect of the present invention there is provided an apparatus for determining the content or measuring the quantity of constituents, of a plurality of samples, the apparatus comprising:

a first plate comprising a plurality of wells, each well being capable of containing a sample;

a second plate comprising a plurality of wells, each well of the second plate being capable of containing an indicating means; and

a means to connect the first plate to the second plate wherein at least one well of the first plate communicates with at least one well of the second plate.

Preferably, each well of the first plate communicates with a single well of the second plate.

Preferably, the means to connect the first and second plate is a third plate. Preferably, a first face of the third plate has a means to seal the third plate to each well of the first plate. Preferably, the second, opposite, face of the third plate has a means to seal the third plate to each well of the second plate. Preferably, the means to seal the third plate to each well of the first or second plate comprising a plurality of protrusions extending from the third plate. Preferably, each protrusion on the first side of the third plate is opposite a protrusion on the second side of the third plate.

Preferably, the third plate further comprises a plurality of apertures to provide a passage between each well of the first plate and each well of the second plate. Typically, the apertures extend from the first side of the third plate to the second side of the third plate. Preferably, the apertures of the third plate are provided through the opposite protrusions of the third plate.

For certain embodiments, the first or second plates have a means to puncture the third plate to provide the apertures. Preferably, the means to puncture the third plate comprise a plurality of needles. Preferably, the needles are hollow. Preferably, each needle communicates with a single well in the first or second plate. Preferably, the needles extend through the third plate and into the opposite well of the second or first plate.

Preferably, the first plate is a deepwell plate. Preferably, the second plate is a microtitre plate. Preferably, there are ninety-six wells in each of the first and second plates although it will be appreciated that any number of wells may be provided in each plate.

Optionally, the third plate may be a lid of the first or second plates. Alternatively, the third plate could be provided as a separate component.

Preferably, the samples comprise soil. Preferably, the sample also comprises a substrate. The substrate may be glucose or any other synthetic or natural organic compound or polymer.

Preferably, the indicator means is provided in a gel. The gel and indicator means may include an alkali such as bicarbonate or soda-lime although this may vary depending on the nature of the sample.

According to a second aspect of the invention there is provided an apparatus to add a sample to a plurality of wells of a fourth plate, the apparatus comprising:

a fifth plate adapted to connect with the fourth plate, the fifth plate having a plurality of wells, at least one of the wells having a removable bottom;

wherein removal of the bottom of at least one well of the fifth plate allows said at least one well of the fifth plate to communicate with at least one well of the fourth plate.

Preferably, the fourth plate is the first plate according to the first aspect of the invention.

Preferably, the bottom of all wells of the fifth plate are provided as a single sixth plate. Preferably, the sixth plate is adapted to slide between the fourth and fifth plates.

Preferably, each well of the fourth plate communicates with a single well of the fifth plate when the sixth plate is removed.

According to a third aspect of the invention there is provided a method of determining the content, or measuring the quantity of constituents, of a plurality of samples, the method comprising the steps of:

providing a first plate comprising a plurality of wells, each well containing a sample;

providing a second plate comprising a plurality of wells, each well of the second plate containing an indicating means;

providing a means to connect the first plate to the second plate;

connecting the first plate to the second plate wherein at least one well of the first plate communicates with at least one well of the second plate;

allowing the fluids of each sample to interact with the indicator means; and

analyzing at least one of the indicator means or sample.

Preferably, the method according to the third aspect of the invention is performed using apparatus according to the first aspect of the invention.

Preferably, the first plate of the third aspect of the invention is the first plate according to any previous aspect of the invention. Preferably, the second plate of the third aspect of the invention is the second plate according to any previous aspect of the invention.

Preferably, the indicating means are analysed. Absorbance measurements may be used to analyse the indicator means. Alternatively, the samples may be radio-labelled and the indicator means may be tested for levels of radioactivity.

According to a fourth aspect of the invention there is provided a method to add a sample to a plurality wells of a fourth plate, the method comprising the steps of:

providing a fifth plate adapted to connect with the fourth plate, the fifth plate having a plurality of wells, at least one of the wells having a removable bottom;

adding the sample to at least one well of the fifth plate;

removing the bottom of the at least one well of the fifth plate;

allowing at least some of the sample in the at least one well of the fifth plate to move into the well of the fourth plate.

Preferably, the method according to the fourth aspect of the invention is performed with apparatus according to the second aspect of the invention.

Preferably, the bottom of all wells of the fifth plate are removed. Preferably, the fifth plate of the fourth aspect of the invention is the fifth plate according to the second aspect of the invention.

According to a fifth aspect of the invention there is provided a means to connect a first plate having a plurality of apertures to a second plate having a plurality of apertures.

Preferably, the first plate of the fifth aspect of the invention is the first plate according to any previous aspect of the invention. Preferably, the second plate of the fifth aspect of the invention is the second plate according to any previous aspect of the invention.

Preferably, the means to connect the plates of the fifth aspect of the invention is the third plate according to any previous aspect of the invention.

According to a sixth aspect of the invention there is provided a method to connect a first plate having a plurality of apertures to a second plate having a plurality of apertures, the method comprising the steps of:

providing a means to connect the first plate to the second plate;

connecting the first plate to the second plate wherein at least one aperture of the first plate communicates with at least one aperture of the second plate.

Preferably, the apertures are wells. Preferably, each well of the first plate communicates with a single well of the second plate.

Preferably, the first plate of the sixth aspect of the present invention is the first plate according to any previous aspect of the invention. Preferably, the second plate of the sixth aspect of the invention is the second plate according to any previous aspect of the invention.

Preferably, the means to connect the first plate to the second plate of the sixth aspect of the invention is the third plate according to any previous aspect of the invention.

### BRIEF DESCRIPTION OF THE DRAWINGS

An embodiment of the invention will now be described by way of example only, with reference to the accompanying drawings wherein:

FIG. 1 is an exploded view of a detection plate, deepwell plate and connection means in accordance with the first and third aspects of the invention; and,

FIG. 2 is a schematic view of a single well of the detection plate and a corresponding well of a deepwell plate.

### DESCRIPTION OF A PREFERRED EMBODIMENT

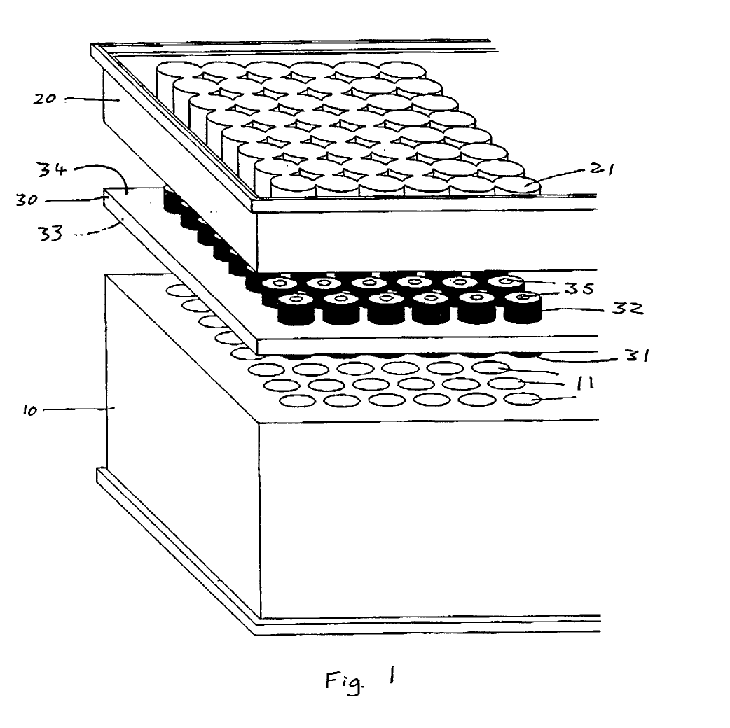

A testing apparatus is shown in FIG. 1 comprising a first, deepwell plate 10, a second, detection plate 20 and a third, connection plate 30 or gasket 30 in accordance with the present invention.

The deepwell plate 10 has forty eight wells 11. More wells (not shown) are typically provided so that there are ninety six wells 11 in total, although it will be appreciated by those skilled in the art that any number of wells may be provided in the deepwell plate 10.

Corresponding wells 21 are provided in the detection plate 20 and are typically shallower than the wells 11 of the deepwell plate 10. Normally an equal number of wells 21 are provided in the detection plate 20. Typically, the detection plate 20 is a microtitre plate 20.

The gasket 30 has pegs 31 extending from a first (lower most in FIG. 1) face 33, and further pegs 32 extending from an opposite (upper most in FIG. 1) face 34 so that each peg 31 has an opposite peg 32.

The pegs 31, 32 are sized to fit into the wells 11, 21 and provide a seal therein between the pegs 31, 32 and wells 11, 21. This is normally achieved by using a resilient material such as rubber, for the pegs 31, 32; alternatively a frictional seal between the wells 11, 21 and pegs 31, 32 may be provided. Further alternatively, the pegs 31, 32 may be omitted from the gasket 30, where the seal between the gasket 30 and the deep well 10 and detection plates 20 is provided by clamping the three plates together.

Apertures 35 extend through each peg 31, through the gasket 30 and through an opposite peg 32.

In alternative embodiments, the deepwell plate 10 (or the detection plate 20) is provided with hollow needles (not shown) which extend from each well 11 (or 21). The detection plate 20 (or 10) has a lid which is pierced by each needle which continues into the well 21 (or 11) so that each well 21 of the detection plate 20 communicates with each well 11 of the deepwell plate 10 via a hollow needle. Thus, the plates 10, 20 can be connected by such a lid formed on either plate 10, 20 rather than a separate component in the form of gasket 30.

The wells 11 of the deepwell plate 10 are filled to the desired level with soil 12 and a substrate such as glucose or any other synthetic or natural organic compound or polymer.

Typically, each well 11 is filled with the same quantity of soil 12 by use of a filling tray (not shown) described below. The different substrates added to each well cause a different amount of carbon dioxide (CO₂) to be given off or respired depending on the particular type of microorganisms present in the soil sample 12. It should be noted that the wells 11 could be provided to the user pre-partially filled with a suitable substitute or could be partially filled by the user with substitute at the time of use.

A gel with a pH indicator 22 is provided in each well 21 of the detection plate 20. In this example the gel comprises Agar, 2 mMol NaHCO₃, 100 mMol KCl and 10 gml⁻¹ cresol red. A method for the measurement of CO₂ is described in Rowell M. J. (1995) Colorimetric method for CO₂ measurement in soils. Soil Biology & Biochemistry 27 (3):373-375. However, the skilled reader will appreciate that a variety of gels and indicators may be used, for example sodium hydroxide with universal indicator.

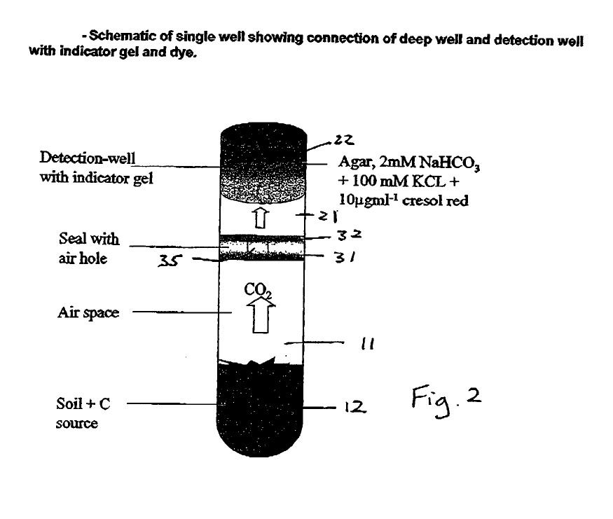

The first face 33 of the gasket 30 is then attached to the deepwell plate 10 so that each peg 31 fits into and seals a corresponding well 11. The detection plate 20 is then attached to the second face 34 of the gasket 30 so that each pegs 32 fits into and seals the wells 21. The wells 11 of the deepwell plate 10 therefore communicate with the wells 21 of the detection plate 20 via the apertures 35 which extend through the pegs 31, 32 and gasket 30, and are also sealed from each other, as shown in FIG. 2 for a single well assembly 11, 21.

The micro-organisms in the soil sample respire the various substrates provided in the wells 11 thereby producing CO₂. The amount of CO₂ produced depends on the nature and quantity of the micro-organisms present and on the type of substrate added to the sample 12. The CO₂ disperses through the aperture 35 and into the well 21 of the detection plate 20 where it interacts with the gel 22 and indicator dye causing the indicator dye to change colour. Typically, the amount of CO₂ produced is proportional to the change in colour of the indicator.

Once sufficient time has elapsed for the CO₂ to be released from the sample, the detection plate 20 is removed and placed in a conventional automated plate reader (not shown) well known in the art. The plate reader measures the absorbance (i.e. colour) of each well 21 of the detection plate 20. This data can then be used to determine the amount of CO₂ respired by the micro-organisms in the sample 12 in the corresponding well 11, which in turn and when combined with information relating to the type of substrate added to each well 11 provides information on the quantity and nature of micro-organisms in the sample 12. Once the data from each well 22 is computed a catabolic fingerprint of the community or Community Level Physiological Profile (CLPP) of whole-soil microbial communities is obtained.

An advantage of the use of gel in the detection plate 20 is that the reaction of the CO₂ with the indicator 22 is effected when the detection plate 20 is upside down. A further advantage is that the optical path length is fixed and unaffected by movement when the detection plate is read in a plate reader.

Thus the use of gel 12 with an added indicator for certain embodiments facilitates the sample testing system so as to allow rapid, automated quantitative measurement of absorbance (colour).

A further advantage of certain embodiments of the present invention is that the process of measuring soil respiration and Substrate-Induced Respiration (SIR) have been miniaturized in a microtitre plate 20 (i.e. the detection plate 20) system so that the reading of the CO₂ reactions can be carried out using conventional automated plate readers that are rapid with automatic data capture and processing.

In alternative embodiments, radioactive substrates are added to the soil sample 12 and an alkali is provided in the detection plate 20 instead of the gel 22 with the indicator. The respired CO₂ (which is radio-labelled) from the soil/radioactive substrate sample is trapped in the alkali provided in the wells 21 of the detection plate 20 and conventional means are used to measure the level of radioactivity emitted from the each well 21 of the detection plate 20. From these levels the amount of CO₂ trapped in the alkali can be calculated. As described above, the amount of CO₂ produced when combined with other data provides information on the nature and quantity of microorganisms present in the soil sample and, along with the results from the other wells, a community or Community Level Physiological Profile (CLPP) can be obtained.

In order to conveniently fill each well 11 of the deepwell plate 10 with the same quantity of soil, a filling device (not shown) is used according to the second and fourth aspects of the invention. The filling device comprises a plate (not shown) with a plurality of wells (not shown). The bottom of each well is provided by a tray which can be removed (normally by sliding out from the plate).

In use, soil is filled to the top of the wells of the filling device and levelled off so that a constant volume has been measured out. The filling device is then held over or connected to the deep-well plate 10 and the tray removed to let the measured volume of soil fall into the wells 11 of the deepwell plate 10. Thus each well 11 of the deepwell plate 10 can be conveniently and accurately filled with the soil sample prior to determining its profile as described above.

The method and apparatus according to the various aspects of the present invention may be used in other applications in addition to substrate induced respiration, for example basal respiration, toxicity tests (e.g. pollution induced community tolerance to heavy metals or other chemical stresses), pollutant degradation tests, biodegredation tests as well as a general assessment of the community level physiological profile. In addition, the method and apparatus according to the various aspects of the present invention may be used to detect other volatile compounds, for example methane, hydrogen sulphide, ammonia as well as CO₂ by use of appropriate respective indicators. Also, embodiments of the present invention can be used to test any biologically active material such as water, wastes such as sludge, tissues such as plant, animal or human tissues and microbial cells as well as soil.

Moreover the method and apparatus are not limited to the field of soil science and may be used in any field where multiple diagnostic tests are commonly used, for example in researching other materials or for medical tests on body fluids.

Modifications and improvements may be made without departing from the scope of the invention.

We claim:

1. An apparatus for determining the content or measuring the quantity of constituents, of a plurality of samples, the apparatus comprising:
a first plate comprising a plurality of wells, each well being capable of containing a sample;
a second plate comprising a plurality of wells, each well of the second plate being capable of containing an indicator means; and
a connection device to connect the first plate to the second plate wherein at least one well of the first plate communicates with at least one well of the second plate.

2. An apparatus according to claim 1, wherein each well of the first plate communicates with a single well of the second plate.

3. An apparatus according to claim 1, wherein the connection device comprises a third plate.

4. An apparatus according to claim 3, wherein a first face of the third plate is capable of sealing the third plate to each well of the first plate and a second, opposite, face of the third plate is capable of sealing the third plate to each well of the second plate.

5. An apparatus according to claim 4, wherein the sealing capability of the third plate to each well of the first or second plate comprise a plurality of protrusions extending from the third plate.

6. An apparatus according to claim 5, wherein each protrusion on the first side of the third plate is opposite a protrusion on the second side of the third plate.

7. An apparatus according to claim 3, wherein the third plate further comprises a plurality of apertures to provide a passage between each well of the first plate and each well of the second plate.

8. An apparatus according to claim 7, wherein the apertures extend from the first side of the third plate to the second side of the third plate.

9. An apparatus according to claim 7, wherein the apertures of the third plate are provided through the opposite protrusions of the third plate.

10. An apparatus according to claim 7, wherein at least one of the first and second plates comprises a puncturing device to puncture the third plate to provide the apertures.

11. An apparatus according to claim 10, wherein the puncturing device comprises a plurality of needles.

12. An apparatus according to claim 11, wherein each needle communicates with a single well in the first or second plate.

13. An apparatus according to claim 11, wherein the needles extend through the third plate and into the opposite well of the second or first plate.

14. An apparatus according to claim 1, wherein the first plate is a deepwell plate and the second plate is a microtitre plate.

15. An apparatus according to claim 1, wherein the samples comprise soil and a substrate.

16. An apparatus according to claim 15, wherein the substrate includes at least one material selected from a group consisting of:
glucose;
synthetic organic compound;
natural organic compound;
synthetic organic polymer; and
natural organic polymer.

17. An apparatus according to claim 1, wherein the indicator means is provided in a gel.

18. An apparatus according to claim 17, wherein the gel and indicator means include an alkali.

19. An apparatus to add a sample to a plurality of wells of a fourth plate, the apparatus comprising:
a fifth plate adapted to connect with the fourth plate, the fifth plate having a plurality of wells, at least one of the wells having a removable bottom;
wherein removal of the bottom of at least one well of the fifth plate allows said at least one well of the fifth plate to communicate with at least one well of the fourth plate.

20. An apparatus according to claim 19, further comprising a means to connect the fourth plate to the fifth plate wherein at least one well of the fourth plate communicates with at least one well of the fifth plate.

21. An apparatus according to claim 19, wherein the bottom of all wells of the fifth plate are provided as a single sixth plate.

22. An apparatus according to claim 21, wherein the sixth plate is adapted to slide between the fourth and fifth plates.

23. An apparatus according to claim 21, wherein the each well of the fourth plate communicates with a single well of the fifth plate when the sixth plate is removed.

24. A method of determining the content, or measuring the quantity of constituents, of a plurality of samples, the method comprising the steps of:
providing a first plate comprising a plurality of wells, each well containing a sample;
providing a second plate comprising a plurality of wells, each well of the second plate containing an indicator means;
providing a means to connect the first plate to the second plate;
connecting the first plate to the second plate wherein at least one well of the first plate communicates with at least one well of the second plate;
allowing the fluids of each sample to interact with the indicator means; and
analyzing at least one of the indicator means or sample.

25. A method according to claim 24, wherein the indicator means are analyzed.

26. A method according to claim 25, wherein absorbance measurements are used to analyze the indicator means.

27. A method according to claim 25, wherein the samples are radio-labelled and the indicator means is tested for levels of radioactivity.

28. A method to add a sample to a plurality of wells of a fourth plate, the method comprising the steps of:
providing a fifth plate adapted to connect with the fourth plate, the fifth plate having a plurality of wells, at least one of the wells having a removable bottom;
adding the sample to at least one well of the fifth plate;
removing the bottom of the at least one well of the fifth plate; and
allowing at least some of the sample in the at least one well of the fifth plate to move into the well of the fourth plate.

29. An apparatus according to claim 28, wherein the bottom of all wells of the fifth plate are removed.

30. A means to connect a first plate having a plurality of apertures to a second plate having a plurality of apertures.

31. A means to connect according to claim 30, wherein the means to connect the plates comprises a third plate.

32. A method to connect a first plate having a plurality of apertures to a second plate having a plurality of apertures, the method comprising the steps of:
providing a means to connect the first plate to the second plate; and
connecting the first plate to the second plate wherein at least one aperture of the first plate communicates with at least one aperture of the second plate.

33. A method according to claim 32, wherein the apertures are wells and each well of the first plate communicates with a single well of the second plate.
